(19) United States
(12) Patent Application Publication
(10) Pub. No.: US 2017/0064325 A1
(43) Pub. Date: Mar. 2, 2017

(54) METHOD AND APPARATUS FOR INTERPOLATING VIDEO FRAME BY USING SUPPLEMENTAL INFORMATION

(71) Applicants: SAMSUNG ELECTRONICS CO., LTD, SUWON-SI (KR); KOREA ADVANCED INSTITUTE OF SCIENCE AND TECHNOLOGY, DAEJEON (KR)

(72) Inventors: HYUNG-JUN LIM, SEOUL (KR); HYUN-WOOK PARK, DAEJEON (KR); PYEONG-GANG HEO, DAEJEON (KR); DONG-YOON KIM, SUWON-SI (KR)

(73) Assignees: SAMSUNG ELECTRONICS CO., LTD., SUWON-SI (KR); KOREA ADVANCED INSTITUTE OF SCIENCE AND TECHNOLOGY, DAEJEON (KR)

(21) Appl. No.: 15/172,525

(22) Filed: Jun. 3, 2016

(30) Foreign Application Priority Data
Sep. 2, 2015 (KR) 10-2015-0124234

(51) Int. Cl. H04N 19/51; H04N 19/184

(52) U.S. Cl. CPC H04N 19/51; H04N 19/184

(57) ABSTRACT

A method and an apparatus for interpolating a video frame are provided. The method and apparatus receive supplemental information associated with segments of a frame of an original video divided into a plurality of areas, estimate a motion vector between first and second frame segments by using the supplemental information, and interpolate a third frame segment between the first and second frame segments based on one of the first and second frame segments and the estimated motion vector.

### CROSS-REFERENCE TO RELATED APPLICATIONS

This application claims the benefit of Korean Patent Application No. 10-2015-0124234, filed on Sep. 2, 2015, in the Korean Intellectual Property Office, the disclosure of which is incorporated herein in its entirety by reference.

### BACKGROUND

1. Field

The present disclosure relates to a method and an apparatus for interpolating a video frame by using supplemental information, and more particularly, to a method and an apparatus for performing an interpolation between decoded frames by using supplemental information associated with a segment of a frame of an original video divided into a plurality of areas to generate a new frame so as to convert a frame rate.

2. Description of the Related Art

The recent development of display apparatuses has increased demands for image formats having various sizes and huge videos having high-definition. However, a bit rate is reduced to a range within an allowed bandwidth in consideration of a bit bandwidth to transmit high-definition data in a limited bandwidth. Therefore, a subjective image quality of a high-definition video may be lowered. Methods of converting a frame rate of an original video have been recently commercialized to prevent an image quality from being lowered due to a reduction in a bit rate as described above. For example, when a frame rate of an original video is 60 Hz, frames of the original video may be interpolated to generate an interpolated frame so as to convert the frame rate into 120 Hz or 240 Hz. A video having a smaller number of afterimages may be produced and played according to a frame rate conversion.

### SUMMARY

Provided are a method and an apparatus for converting a frame rate.

Provided is a non-transitory computer readable recording medium having recorded thereon a program for executing the method.

Provided are a method and an apparatus for generating an interpolated frame by using supplemental information generated at a video compression node instead of generating an interpolated frame between consecutive frames by using merely a decoded video at a video reception node.

Additional aspects will be set forth in part in the description which follows and, in part, will be apparent from the description, or may be learned by practice of the presented embodiments.

According to an aspect of an embodiment, a method of interpolating a video frame, includes: receiving supplemental information associated with segments of a frame of an original video divided into a plurality of areas; estimating a motion vector between first and second frame segments by using the supplemental information; and interpolating a third frame segment between the first and second frame segments based on one of the first and second frame segments and the estimated motion vector.

The supplemental information may include information about at least one selected from a representative motion vector of the segment, center coordinates of the segment, a width of the segment, a boundary determination threshold value of the segment, and a depth of the segment.

The supplemental information may be information that is generated by segmenting a motion vector into preset data units. The motion vector may be generated by performing a motion estimation with respect to a frame of the original video that is not encoded.

The receiving of the supplemental information may include receiving the supplemental information through a bitstream for transmitting encoded video information.

The receiving of the supplemental information may include receiving the supplemental information through a supplementary enhancement information (SEI) message.

The estimating of the motion vector may include: allocating the representative motion vector as a seed motion vector to the center coordinates of the segment; estimating a motion vector of an area adjacent to the seed motion vector with reference to the seed motion vector; and estimating motion vectors of other areas of the segment with reference to the estimated motion vector.

The supplemental information may include a flag indicating whether a motion vector does not exist in the segment or an occlusion area that is an inaccurate area exists in the segment. If the occlusion area exists in the segment, the estimating of the motion vector may include using a motion vector as a motion vector of the segment, wherein the motion vector is generated by performing a motion estimation with respect to a frame of the original video.

According to an aspect of another embodiment, an apparatus for interpolating a video frame, includes: a supplemental information receiver configured to receive supplemental information associated with segments of a frame of an original video divided into a plurality of areas; a motion estimator configured to estimate a motion vector between first and second frame segments by using the supplemental information; and a frame interpolator configured to interpolate a third frame segment between the first and second frame segments based on one of the first and second frame segments and the estimated motion vector.

The supplemental information may include information about at least one selected from a representative motion vector of the segment, center coordinates of the segment, a width of the segment, a boundary determination threshold value of the segment, and a depth of the segment.

The supplemental information may be information that is generated by segmenting a motion vector into preset data units. The motion vector may be generated by performing a motion estimation with respect to the frame of the original video that is not encoded.

The supplemental information receiver may receive the supplemental information through a bitstream for transmitting encoded video information.

The supplemental information receiver may receive the supplemental information through an SEI message.

The motion estimator may allocate the representative motion vector as a seed motion vector to the center coordinates of the segment and estimate a motion vector of an area adjacent to the seed motion vector with reference to the seed motion vector to estimate motion vectors of other areas of the segment with reference to the estimated motion vector.

The supplemental information may include a flag indicating whether a motion vector does not exist in the segment or an occlusion area that is an inaccurate area exists in the segment. If the occlusion area exists in the segment, the motion estimator may use a motion vector as a motion vector of the segment. The motion vector may be generated by performing a motion estimation with respect to a frame of the original video.

### BRIEF DESCRIPTION OF THE DRAWINGS

These and/or other aspects will become apparent and more readily appreciated from the following description of the embodiments, taken in conjunction with the accompanying drawings in which:

FIG. 1A is a diagram illustrating a method of interpolating a video frame;

FIG. 1B is a diagram illustrating a method of interpolating a video frame according to an embodiment;

FIG. 2 is a block diagram of a configuration of an apparatus for interpolating a video frame, according to an embodiment;

FIG. 3 is a flowchart of a method of generating supplemental information according to an embodiment;

FIG. 4 is a reference view illustrating a process of segmenting a motion vector generated by performing a motion estimation with respect to a frame of an original video;

FIG. 5 is a reference table illustrating types of information included in supplemental information;

FIG. 6 is a flowchart of a method of interpolating a frame by using supplemental information, according to an embodiment;

FIG. 7 is a reference view illustrating a method of up-converting a frame rate of an image;

FIG. 8 is a reference view illustrating a flag indicating whether an occlusion area exists in a segment; and

FIG. 9 is a flowchart of a method of interpolating a video frame, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. Expressions such as “at least one of,” when preceding a list of elements, modify the entire list of elements and do not modify the individual elements of the list.

The terms first, second, A, B, etc. may be used herein to descibe various elements, these elements may not be limited by these terms. These terms are merely used to distinguish one element from another element. For example, a first element may be termed a second element, and similarly, a second element may be termed a first element without departing from the scope of embodiments. As used herein, the term “and/or” includes any and all combinations of one or more of the associated listed items.

It will be understood that when an element is referred to as being “connected to” or “coupled to” another element, it may be directly connected or coupled to other mement or intervening elements may be present. In contrast, when an element is referred to as being “directly connected to” or “directly coupled to” another element, there are no intervening elements present.

The terminology used here is for describing paticular embodiments merely and is not intended to be limiting of embodiments. As used herein, the singular forms include plural forms as well, unless the context clearly indicates otherwise. It will be understood that the terms “comprises” and/or “comprising” when used in this specifiction, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which embodiments belong. It will further understood that terms, such as those defined in commonly used directionaries, may be interpreted as having a meaning that is consistent with their meaning in the context of the relevant art and will not be interpreted in an idealized or overly formal sense unless expressly so defined herein.

Hereinafter, embodiments will be described in detail with reference to the attached drawings.

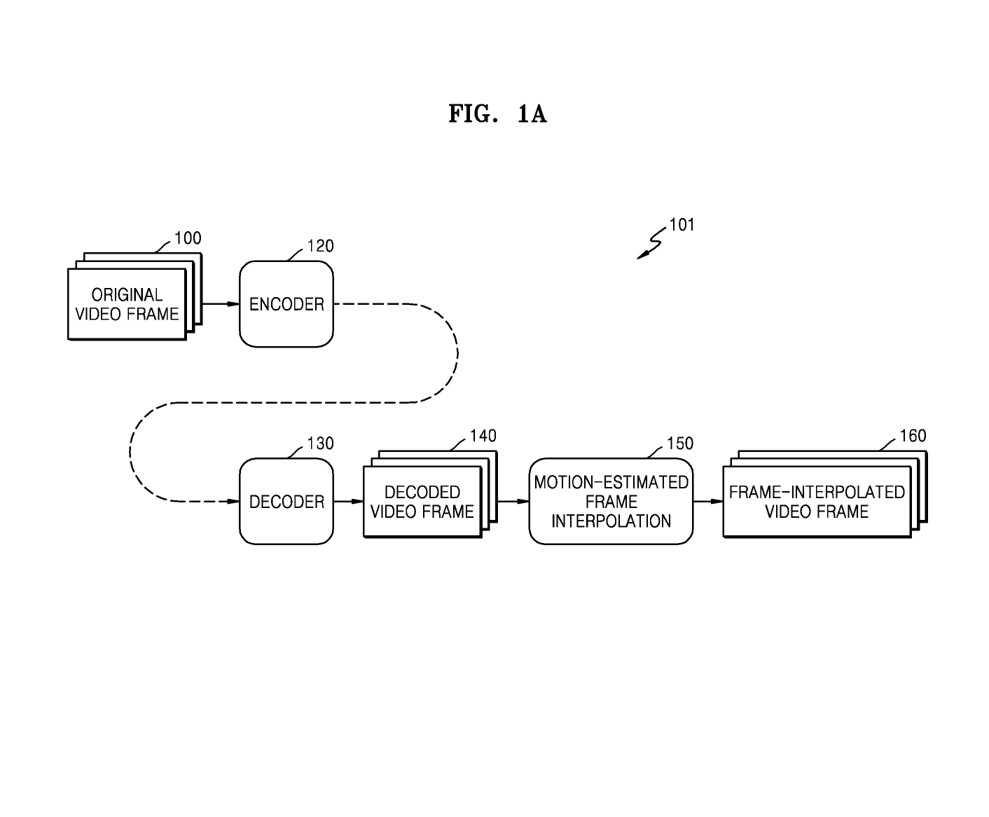

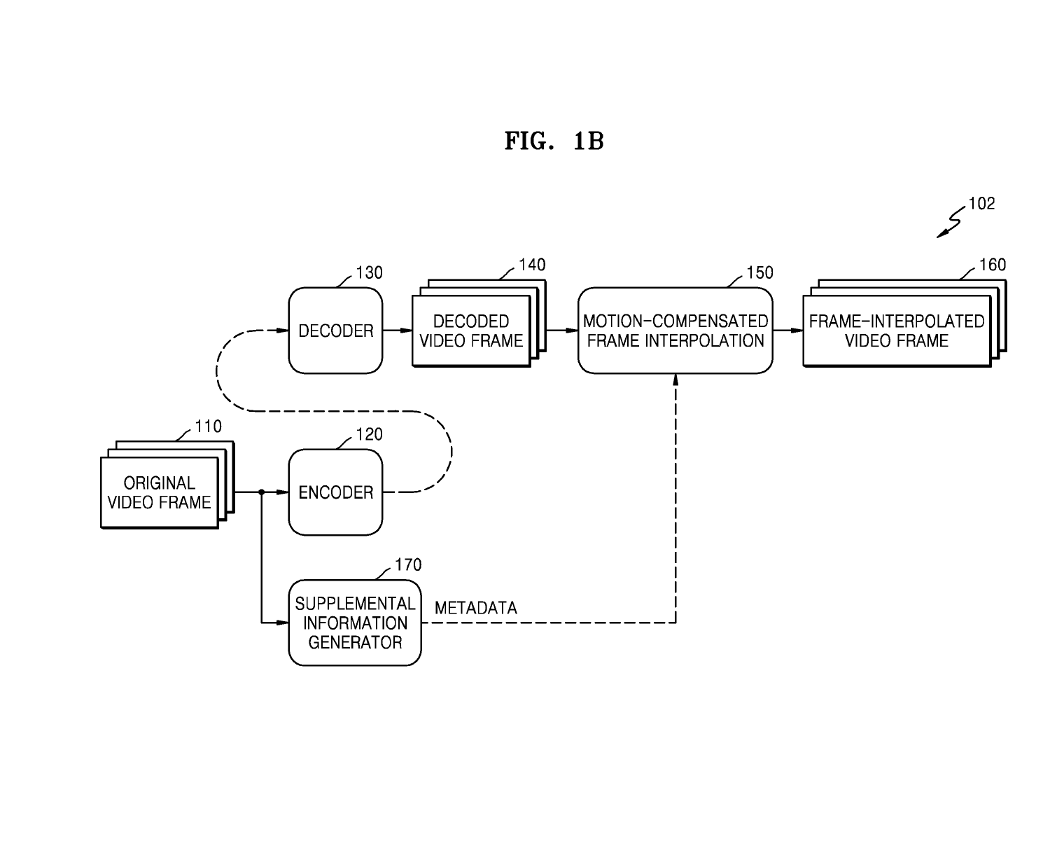

FIG. 1A is a diagram 101 illustrating a method of interpolating a video frame. Referring to FIG. 1A, in an operation of compressing a video, an encoder 120 converts, quantizes, and encodes an original video frame 110 to convert the original video frame 110 into a bitstream. When compressing a video, various types of technologies may be used to remove a temporal redundancy existing between videos and a spatial redundancy in a video. Data that is converted into a bitstream by the encoder 120 is received by a decoder 130 to be output as a decoded video frame 140. Here, in comparison with the original video frame 110, reliability of a motion vector of the decoded video frame 140 that is estimated between consecutive frames may be relatively lowered. Since it is very difficult to transmit a high-definition video in a limited bandwidth without a data loss, a coding artifact exits in the decoded video frame 140.

Various types of frame rate up-conversion technologies are used to solve a problem of the coding artifact of the decoded video frame 140 described above. A frame rate up-conversion technology refers to a technology that increases a frame rate of a video by using an existing frame and may provide a larger number of videos for the same time to reduce a time for maintaining pixel values per frame so as to solve a screen dragging phenomenon.

As a representative method of frame rate up-conversions, there is a method of adding consecutive frames and a method of interpolating a video by using a motion compensation.

The method of adding the consecutive frames does not consider a motion of an object and thus easily enables an interpolation at a low complexity. However, if a format of a video is expanded or a motion of an object is large, a ghost artifact and a screen dragging phenomenon, where a video is not even and videos overlap with each other, occur. Also, since interpolations are respectively performed with respect to blocks, a block artifact occurs at a boundary part between the blocks.

A motion-compensated frame interpolation (referred to as an MCFI) method of interpolating a video by using a motion compenstation refers to a method of estimating a motion of an object in a neighboring frame to generate a new video. In comparison with the method of adding the consecutive frames, this method demands a complicated operation quantity but may solve a probem such as a screen dragging phenomenon or the like. However, the MCFI method estimates that a block selected by using a motion vector estimated in a previous frame linearly moves in a current frame. Therefore, if a motion vector is not accurately estimated, a wrong location of a motion vector in the current frame may also be selected. As a result, a serious block artifact may occur in an interpolated frame.

The MCFI method may be used as the method of interpolating the video illustrated in FIG. 1 A. A video frame interpolating apparatus may perform a motion estimation between first and second frames, which are temporally located before and after in the decoded video frame 140, to generate a motion vector so as to perform an MCFI 150 with respect to the decoded video frame 140. The video frame interpolating apparatus interpolates a third frame between the first and second frames to generates a frame-interpolated video frame 160 based on the generated motion vector. Here, a method of generating the third frame is not limited, and all of methods of interpolating the third frame based on the motion vector between the first and second frames may be applied.

FIG. 1B is a diagram 102 illustrating a method of interpolating a video frame according to an embodiment. An original video frame 110, an encoder 120, a decoder 130, and a decoded video frame 140 of FIG. 1B respectively correspond to the original video frame 110, the encoder 120, the decoder 130, and the decoded video frame 140, and thus their repeated descriptions are omitted.

Referring to FIG. 1B, the diagram for illustrating the method of interpolating the video frame according to the present embodiment further includes a supplemental information generator 170. To remove a coding artifact of the decoded video frame 140 as described above, a video frame interpolating apparatus 200 may perform a frame interpolation by using supplemental information (e.g., metadata) generated from the supplemental information generator 170 when performing an MCFI 150. The supplemental information generated by the supplemental information generator 170 may be information that is generated by segmenting a motion vector field into preset data units, wherein the motion vector field is generated by performing a motion estimation with respect to the original video frame 110 that is uncoded through the encoder 120. Here, the supplemental information may include various types of information such as a representative motion vector of a segment, a location of center of mass, a width of the segment, a boundary determination threshold value of the segment, a depth of the segment, etc.

Referring to FIG. 1B, the video frame interpolating apparatus 200 receives the supplemental information generated by the supplemental information generator 170 and generates a frame-interpolated video frame 160 by using the supplemental information when performing the MCFI 150. The supplemental information received by the video frame interpolating apparatus 200 includes pieces of supplemental information for improving a performance of an MCFI technique performed in an operation of receiving a video after performing decoding. Therefore, if an MCFI is performed by using supplemental information, a more accurate motion estimation becomes possible, and real-time and high-speed performance of the MCFI becomes possible.

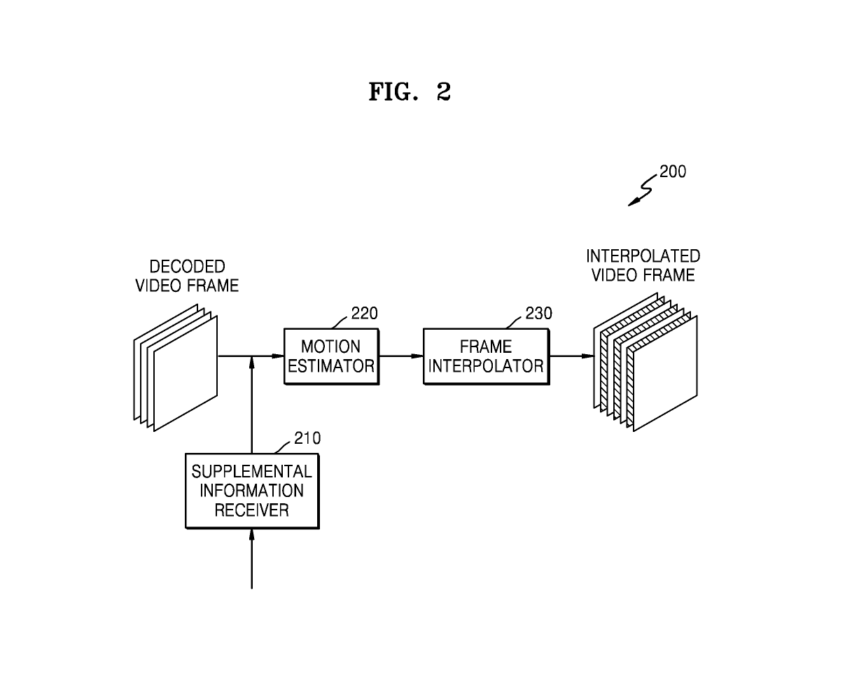

FIG. 2 is a block diagram of a configuration of the video frame interpolating apparatus 200, according to an embodiment.

Referring to FIG. 2, the video frame interpolating apparatus 200 includes a supplemental information receiver 210, a motion estimator 220, and a frame interpolator 230.

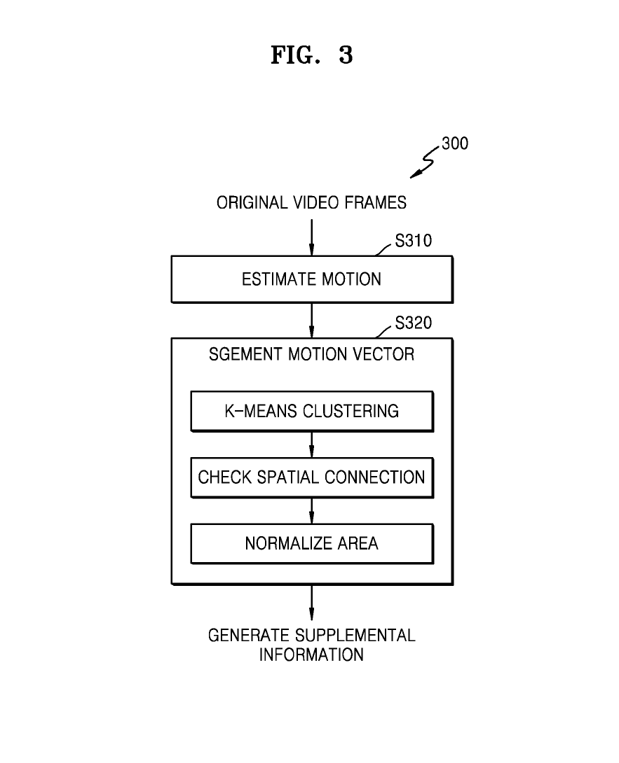

The supplemental information receiver 210 may receive the supplemental information generated by the supplemental information generator 170 along with encoded video information through a bitstream. The supplemental information receiver 210 may also receive the supplemental information generated by the supplemental information generator 170 through a supplementary enhancement information (SEI) message. The supplemental information may be transmitted or received in a metadata form, and a transmission or reception channel may vary according to a type of data and an information amount included in the supplemental information. A detailed process of generating the supplemental information received by the supplemental information receiver 210 will be described later with reference to FIGS. 3 through 5.

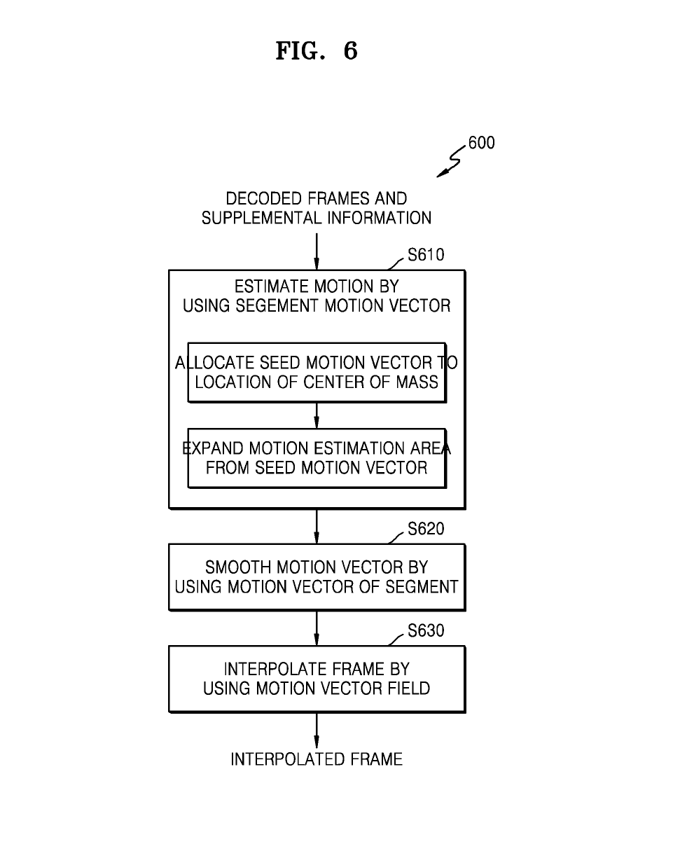

The motion estimator 220 may perform a motion estimation between first and second frames, which are temporally located before and after, to generate a motion vector so as to generate an interpolated frame between temporally consecutive frames of a decoded video frame. Here, the motion estimator 220 may estimate a motion vector between first and second frame segments by using the supplemental information received through the supplemental information receiver 210. A detailed operation of the motion estimation performed by the motion estimator 220 will be described later with reference to FIGS. 6 through 8.

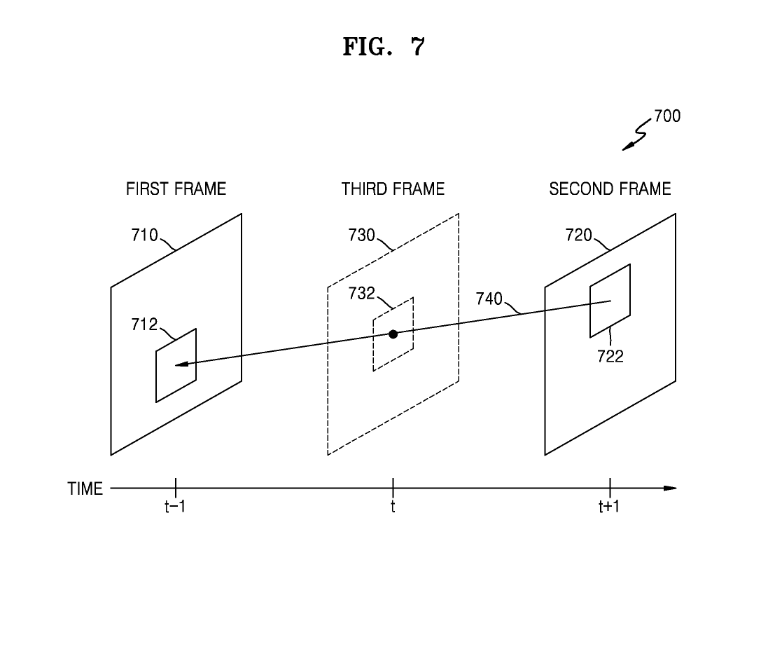

The frame interpolator 230 interpolates a third frame between first and second frames based on the motion vector generated by the motion estimator 220. Here, a method of generating the third frame through the frame interpolator 230 is not limited, and thus all of methods of interpolating the third frame based on the motion vector between the first and second frames may be applied in embodiments. The method of generating the third frame by using the first and second frames will be described in detail later with reference to FIG. 7.

A method of increasing a frame rate of an existing decoded video generates an interpolated frame between consecutive frames by using merely a decoded video at a video reception node. According to an existing method of interpolating a video frame, a motion vector estimated between consecutive frames accompanies a coding artifact caused by a video compression, and thus a problem of lowering reliability occurs.

The video frame interpolating apparatus 200 according to the embodiment may use supplemental information generated at a video compression node to generate an interpolated frame between consecutive frames so as to remove a coding artifact and further accurately estimate a motion vector between the consecutive frames.

Also, the video frame interpolating apparatus 200 according to the embodiment may increase an accuracy of a motion vector estimation by using a small number of computations and further accurately generate an interpolated frame.

FIG. 3 is a flowchart 300 of a method of generating supplemental information, according to an embodiment.

Referring to FIG. 3, the method includes operation S310 of performing a motion estimation and operation S320 of segmenting a motion vector.

In operation S310 of performing the motion estimation, a motion vector of a current frame may be estimated from a reference frame (e.g., a previous frame) of an original video. Here, the original video that is not encoded may have a higher frame rate than an encoded video, and a motion vector estimated from a frame of the original video may be close to a true motion vector having no error.

In operation S320 of segmenting the motion vector, a motion vector field generated through a motion estimation performed with respect to the frame of the original video may be segmented into preset data units. Pieces of similar vector field data of the motion vector field may be classified into one or more homogeneous clusters through a K-menas clustering technique.

The K-means clustering technique is a kind of non-hierachical clustering technique, i.e., refers to a method of binding n entities into k clusters and binding entities having high similarities into one cluster. A first step of the K-means clustering technique is a process of receiving K cluster centers as input factors and selecting cluster centers by the input K cluster centers. An initial cluster center may be arbitrarily selected. A next step is a process of respectively allocating entities to selected clusters. In this step, similarities between entities are calculated to allocate entities having the highest similarities to a cluster. There are several methods of calculating similarities, and the K-means clustering technique calculates a center value of a new cluster by using an average of entities allocated to each cluster. A cluster center of clustering of parameters higher than a 2-dimension (2D) may be recalculated by using a centroid value instead of an average value. The above-described processes may be repeated until a preset condition is satisfied or a movement of a cluster center disappears.

The K-means clustering technique may find meaningful information without previous knowledge of an internal configuration of whole data. Also, a distance relation between an observation value and a cluster center may be defined so as to be appropriate for a form of data and thus may be applied to most types of data. Although an initial wrong cluster belongs to an entity, the entity may be re-allocated to a valid cluster through repetitions.

In operation S320 of segmenting the motion vector, pieces of similar vector field data may be classified into one or more homogeneous clusters through the K-means clustering technique, and then a segment of a motion vector filed may be generated through a spatial connection check. Segmented areas may be regularized to generate a segment having an improved motion vector. The segment having the improved motion vector may include various types of supplemental information associated with a segment of an original video. Here, segmenting of a motion vector may be performed in unit of frames or may be performed with respect to central terminal units (CTUs), coding units (CUs), or other units.

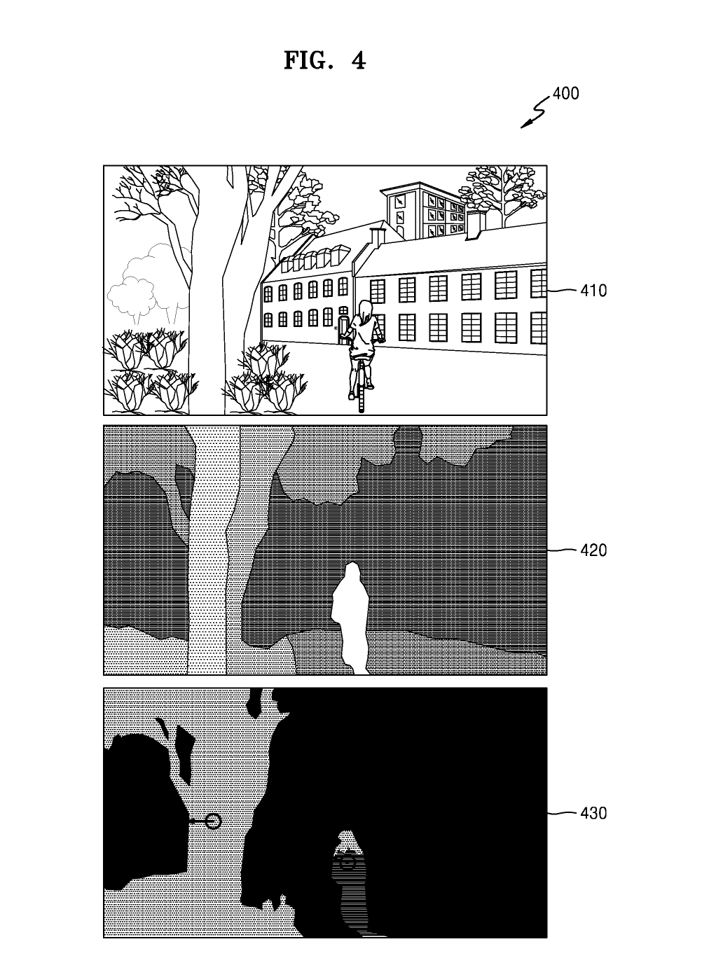

FIG. 4 is a reference view 400 illustrating a process of segmenting a motion vector that is generated by performing a motion estimation with respect to a frame of an orignal video.

A motion estimation may be performed with respect to an orignal video 410 to generate a motion vector field 420 of a current frame. Here, the original video 410 is a video that is not encoded and has a higher frame rate than an encoded video.

The motion vector field 420 may be classified into preset data units through a segementation process 430. In other words, pieces of similar vector field data of the motion vector field 420 may be classified into one or more homogeneous clusters through a K-means clustering technique. Here, supplemental information associated with a segment, such as a representative motion vector of a segment, a location of center of mass, a width of the segment, a boundary determination threshold value of the segment, a depth of the segment, etc., may be extracted from each of the preset data units.

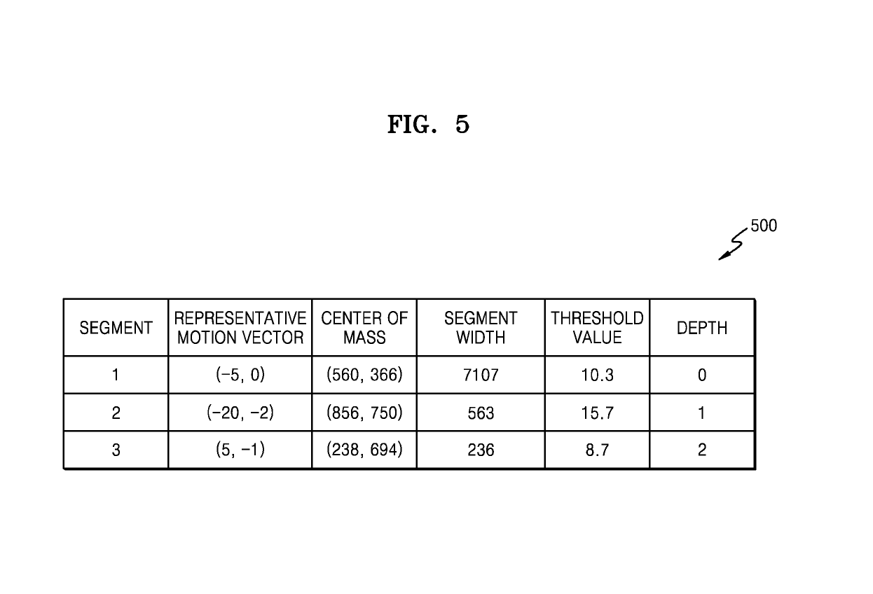

FIG. 5 is a reference table 500 illustrating types of information included in supplemental information.

The supplemental information that is generated through operation S310 of performing the motion estimation and operation S320 of segmenting the motion vector illustrated in FIG. 3 may include various types of information associated with a segment.

Referring to FIG. 5, the supplmental information may include information about at least one selected from a representative motion vector of a segment, a location of center of mass, a width of the segment (the number of pixels), a boundary determination threshol value of the segment, and a depth of the segment, along with information about the segment. Also, the supplemental information may additionally include information about a pixel value of the segment, whether the segment includes an occlusion area, a difference value between a motion vector which is not encoded and an encoded motion vector, etc. The boundary determination threshold value of the segment is a preset value for determining a boundary of the segment. Also, the depth of the segment indicates the number of times the segment being spatially segmented into maximum segmentation units. As the depth of the segment becomes deeper, segements according to depths may be segmented from the maximum segmentation units into minimum segmentation units. As to the maximum segmentation units, as a depth becomes deeper, sizes of segments according to depths decrease, and thus a segment having an upper depth may include a segment having a plurality of lower depths.

FIG. 6 is a flowchart 600 of a method of interpolating a frame by using supplemental information, according to an embodiment.

Referring to FIG. 6, the method includes operation S610 of performing a motion estimation with respect to decoded frames by using a motion vector of a segment, operation S620 of smoothing a motion vector by using a motion vector of the segment, and operation S630 of performing a frame interpolation by using a motion vector field. Operations S610 and S620 may be performed by the motion estimator of FIG. 2, and operation S630 may be performed by the frame interpolator 230 of FIG. 2.

In operation S610, a representative motion vector may be allocated as a seed motion vector in a location of center of mass of each segment by using supplemental information. A motion estimation may be performed in an area around the location of center of mass with reference to the representative motion vector allocated as the seed motion vector. A motion estimation in each segment may be expanded from the location of center of mass into an external area to be sequentially performed. In other words, the seed motion vector and a previously estimated motion vector may be used as reference vectors in a process of acquiring another motion vector.

A motion estimation may be performed by using supplemental information, a motion vector may be smoothed, and a frame interpolation may be performed. The frame interpolation will be described in detail later with reference to FIG. 7.

FIG. 7 is a reference view 700 illustrating a method of up-converting a frame rate of a video.

Referring to FIG. 7, an interpolation is performed between a first frame 710 of time t−1 and a second frame 720 of time t+1 to estimate a motion vector 740 so as to generate a third frame 730. Here, the first frame 710 and the second frame 720 may be frames of an encoded video. The motion estimator 220 searches the first frame 710 for a segement 712 similar to a segment 722 of the second frame 720 and estimates a motion vector 740 based on the search result. Here, the motion estimator 220 refers to supplemental information received by the supplmental information receiver 210 to estimate the motion vector 740. The motion estimator 220 generates the forward motion vector 740 as illustrated in FIG. 7 but is not limited thereto. The motion estimator 220 may perform a motion estimation with respect to the second frame 720 based on the first frame 710 to generate a backward motion vector.

The frame interpolator 230 generates a segment 732 of the third frame 730 between the segment 712 of the first frame 710 and the segment 722 of the second frame 720 based on the motion vector 740 generated by the motion estimator 220. The frame interpolator 230 may also generate the third frame 730 between the first frame 710 and the second frame 720 based on the motion vector 740. The third frame 730 may be a set of segments 732 of the third frame 730 and may be generated based on the segment 732 of the third frame 730. The frame interpolator 230 may use various types of methods of interpolating a farme between video frames based on a motion vector. For example, an MCFI method may be applied to generate the third frame 730. The frame interpolator 230 may interpolate the third frame 730 by using the motion vector 740 estimated from the second frame 720 as in Equation 1 below:

$$\hat{f} ( i + \frac{{v}_{i , j}^{x}}{2} , j + \frac{{v}_{i , j}^{y}}{2} ) = \frac{1}{2} \{ {f}_{t - 1} ( i + {v}_{i , j}^{x} , j + {v}_{i , j}^{y} ) + {f}_{t + 1} ( i , j ) \} \qquad ( 1 )$$

wherein x axis direction component of a motion vector of location (I,j) of the second frame 720 generated by the motion estimator 220 is v_{i,j}^{x} , y axis direction component is v_{i,j}^{y}, fₜ₋₁(x,y) is a pixel value of location (x,y) of the first frame 710, fₜ₊₁(x,y) is a pixel value of location (x,y) of the second frame 720, and \hat{f}ₜ(x,y) is a pixel value of location (x,y) of the interpolated third frame 730. Referring to Equation 1 above, the frame interpolator 230 may calculate an average value between corresponding areas of the segment 712 of the first frame 710 and the segment 722 of the second frame 720 based on the motion vector generated by the motion estimator 220 to interpolate the third frame 730.

Also, the frame interpolator 230 may interpolate the third frame 730 based on a motion vector estimated with respect to each pixel of the third frame 730 as in Equation 2 below:

$$\hat{f} ( i , j ) = \frac{1}{2} \{ {f}_{t - 1} ( i + \frac{{v}_{j , j}^{x}}{2} , j + \frac{{v}_{i , j}^{y}}{2} ) + {f}_{t + 1} ( i - \frac{{v}_{i , j}^{x}}{2} , j - \frac{{v}_{i , j}^{y}}{2} ) \} \qquad ( 2 )$$

wherein v_{i,j}^{x} and v_{i,j}^{y} respectively denote motion vectors of x axis direction and y axis direction estimated in location (k,j) of the third frame 730, and definitions of other parameters are as in Equation 1. A motion vector in the interpolated third frame 730 may be estimated by using various types of methods without a particular limitation by using backward and forward motion vectors of the first frame 710 and the second frame 720.

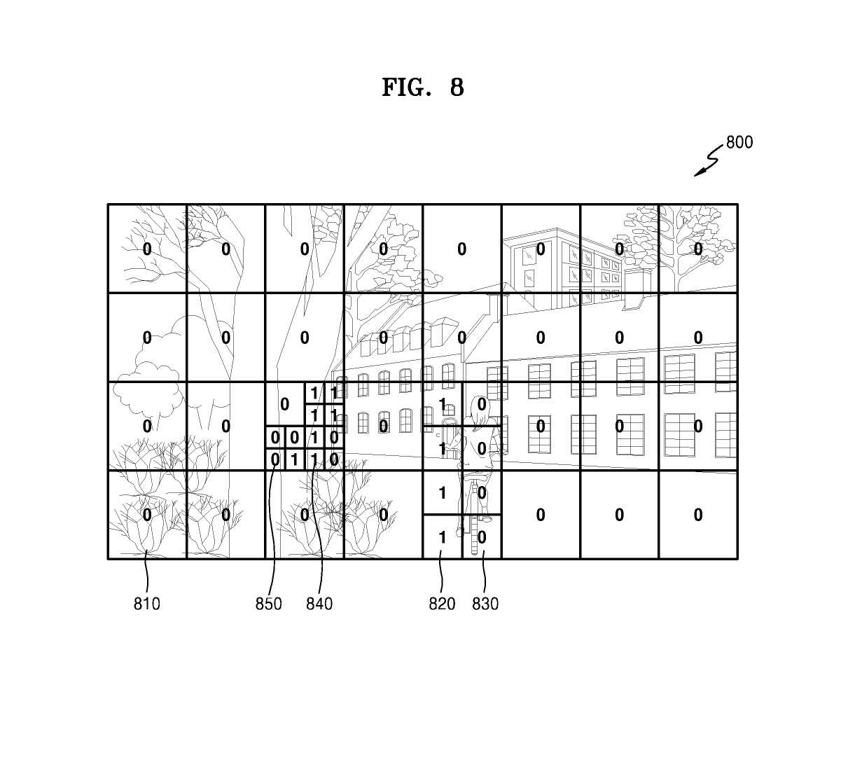

FIG. 8 is a reference view 800 illustrating a flag indicating whether an occlusion area exists in a segment.

The occlusion area refers to an object or an area that exists merely in one of first and second frames temporally adjacent to each other but not in both of the first and second frames. The occlusion area may be included in a frame in a coding process if a video rapidly changes. If an occlusion area exists in frames of an original video, a motion estimation or motion compensation technique may be applied to generate an interpolated frame. The interpolated frame is a new frame that is generated between frames by using motion vector information of temporally adjacent frames. Therefore, if a motion vector does not exist or an unreliable motion vector exists in temporally adjacent frames, the interpolated frame may be generated.

If a segment of a frame includes an occlusion area, the video frame interpolating apparatus 200 acording to an embodiment may receive and use additional information generated from the encoder 120. Here, the additional information may be a true motion vector estimated from a frame of an original video through the encoder 120 or a motion vector difference (MVD) between the true motion vector and a motion vector acquired by performing an MCFI.

If the segment does not include the occlusion area, the video frame interpolating apparatus 200 according to an embodiment may generate an interpolated frame through an MCFI without additional information. However, if the segment includes the occlusion area, the video frame interpolating appartaus 200 may generate an interpolated frame by using the additional information, i.e., the true motion vector or an MVD. The additional information may be transmitted to the video frame interpolating apparatus 200 along with encoded video information. Also, whether to use the additional information may be defined in frames, CTUs, CUs, or the like to be transmitted to the video frame interpolating apparatus 200.

Referring to FIG. 8, supplemental information accoding to an embodiment may include a flag indicating whether an occlusion area exists in a segment. If the flag is 0, the flag indicates that the segment does not include the occulsion area. If the flag is 1, the flag indicates that the segment includes the occlusion area. Referring to FIG. 8, a segment may be divided into lower segments through a quad-tree structure according to depth. Therefore, a flag indicating whether an occlusion area exists may be described in unit of segments having particular depths. In other words, if a unit 810 of a segment having depth of 0 does not include an occlusion area, the flag indicates 0. If a unit of a segment having depth of 0 includes an occlusion area, the segment is divided into segment units 820 and 830 having depths of 1 in a quad-tree form to be respectively described as flags of the segment units 820 and 830. If a segment unit having depth of 1 includes an occlusion area, the segment is divided into segment units 840 and 850 having depths of 2 in a quad-tree form to be respectively described as flags of the segment units 840 and 850.

In the previous dembodiment, a flag is described as indicating whether an occlusion area exists in a segment. However, the flag may be used as a unit for defining whether an occlusion area exists in a segment and whether additional information is used. Here, an image quality that may be improved by using a bit rate generated when additional information is used and the additional information may be measured and compared to determine whether the additional information is used.

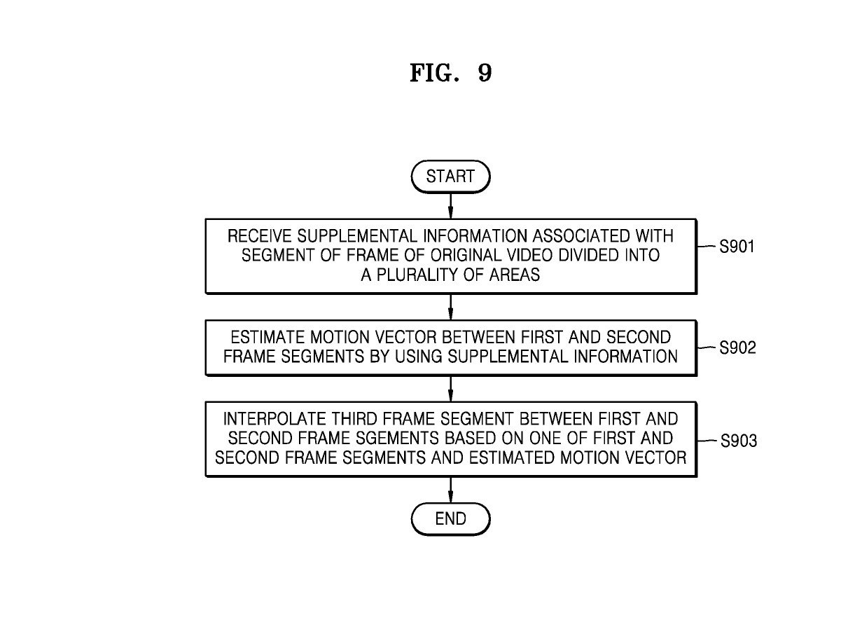

FIG. 9 is a flowchart of a method of interpolating a video frame, according to an embodiment.

Referring to FIG. 9, in operation S910, the supplemental information receiver 210 receives supplemental information associated with a segment of a frame of an original frame divided into a plurality of areas.

In operation S920, the motion estimator 220 estimates a motion vector between a first frame segment and a second frame segment by using the supplemental information.

In operation S930, the frame interpolator 230 interpolates a third frame segment between the first and second frame segments based on one of the first and second frame segments and the estimated motion vector. As described above, a method of interpolating the third frame segement is not limited, and thus all of methods of interpolating the third frame segment based on the motion vector between the first and second frame segments may be applied.

While one or more embodiments have been described with reference to the figures, it will be understood by those of ordinary skill in the art that various changes in form and details may be made therein without departing from the spirit and scope as defined by the following claims. Also, a system according to embodiments may be embodied as a computer readable code on a computer readable recording medium. The computer readable recording medium includes all types of recording devices that store data that may be read by a computer system. Examples of the computer readable recording medium include an ROM, an RAM, a CD-ROM, a magentic tape, a floppy disk, an optical data storage device, etc. Also, the computer readable recording medium may distribute a computer readable code in a computer system connected through a network, and store and execute the computer readable code in a distribution way.

What is claimed is:

1. A method of interpolating a video frame, the method comprising:
receiving supplemental information associated with a plurality of segments of a frame of an original video, wherein the plurality of segments are respectively divided into a plurality of areas;
estimating a motion vector between first and second frame segments among the plurality of segments of the frame by using the received supplemental information; and
interpolating a third frame segment between the first and second frame segments based on one of the first and second frame segments and the estimated motion vector.

2. The method of claim 1, wherein the supplemental information comprises information about at least one of a representative motion vector of a segment among the plurality of segments, center coordinates of the segment, a width of the segment, a boundary determination threshold value of the segment, and a depth of the segment.

3. The method of claim 1, wherein the supplemental information includes information that is generated by segmenting a motion vector into predetermined data units, wherein the motion vector is generated by performing a motion estimation with respect to a frame of the original video that is not encoded.

4. The method of claim 1, wherein the receiving of the supplemental information comprises receiving the supplemental information through a bitstream for transmitting encoded video information.

5. The method of claim 1, wherein the receiving of the supplemental information comprises receiving the supplemental information through a supplementary enhancement information (SEI) message.

6. The method of claim 2, wherein the supplemental information comprises information about the representative motion vector and the center coordinates of the segment, and
wherein the estimating of the motion vector comprises:
allocating the representative motion vector as a seed motion vector to the center coordinates of the segment;
estimating a motion vector of an area adjacent to the seed motion vector with reference to the seed motion vector; and
estimating motion vectors of other areas of the segment with reference to the estimated motion vector.

7. The method of claim 1, wherein the supplemental information comprises a flag indicating whether a motion vector does not exist in a segment among the plurality of segments or an occlusion area that is an inaccurate area exists in the segment,
wherein if the occlusion area exists in the segment, the estimating of the motion vector comprises using a motion vector as a motion vector of the segment, wherein the motion vector is generated by performing a motion estimation with respect to a frame of the original video.

8. An apparatus for interpolating a video frame, the apparatus comprising:
a supplemental information receiver configured to receive supplemental information associated with a plurality of segments of a frame of an original video, wherein the plurality of segments are respectively divided into a plurality of areas;
a motion estimator configured to estimate a motion vector between first and second frame segments among the plurality of segments of the frame by using the received supplemental information; and
a frame interpolator configured to interpolate a third frame segment between the first and second frame segments based on one of the first and second frame segments and the estimated motion vector.

9. The apparatus of claim 8, wherein the supplemental information comprises information about at least one of a representative motion vector of a segment among the plurality of segments, center coordinates of the segment, a width of the segment, a boundary determination threshold value of the segment, and a depth of the segment.

10. The apparatus of claim 8, wherein the supplemental information includes information that is generated by segmenting a motion vector into predetermined data units, wherein the motion vector is generated by performing a motion estimation with respect to the frame of the original video that is not encoded.

11. The apparatus of claim 8, wherein the supplemental information receiver receives the supplemental information through a bitstream for transmitting encoded video information.

12. The apparatus of claim 8, wherein the supplemental information receiver receives the supplemental information through a supplementary enhancement information (SEI) message.

13. The apparatus of claim 9, wherein the supplemental information comprises information about the representative motion vector and the center coordinates of the segment, and
wherein the motion estimator allocates the representative motion vector as a seed motion vector to the center coordinates of the segment and estimates a motion vector of an area adjacent to the seed motion vector with reference to the seed motion vector to estimate motion vectors of other areas of the segment with reference to the estimated motion vector.

14. The apparatus of claim 8, wherein the supplemental information comprises a flag indicating whether a motion vector does not exist in a segment among the plurality of segments or an occlusion area that is an inaccurate area exists in the segment,
wherein if the occlusion area exists in the segment, the motion estimator uses a motion vector as a motion vector of the segment, wherein the motion vector is generated by performing a motion estimation with respect to a frame of the original video.

15. A non-transitory computer readable recording medium having recorded thereon a program for executing the method of claim 1.
